(19) United States
(12) Patent Application Publication
(10) Pub. No.: US 2007/0193081 A1
(43) Pub. Date: Aug. 23, 2007

(54) "Brush-A-Month" toothbrushes

(76) Inventor: Frances Heimann, Las Vegas, NV (US)

Correspondence Address: FRANCES HEIMANN, 7376 COBBLEFIELD STREET, LAS VEGAS, NV, 89123, US

(21) Appl. No.: 11/344,484

(22) Filed: Feb. 1, 2006

(51) Int. Cl. G09F 3/00

(52) U.S. Cl. 40/314

(57) ABSTRACT

What is different and new about this invention becomes immediately apparent upon visual inspection of each series of toothbrushes. The obvious depiction of each month on the handle of handheld toothbrushes and on the head of electric toothbrushes, makes it easy to select any portion or an entire year of brushes for the monthly regiment of keeping oral hygiene current. Further, most dentists not only recommend the monthly changes of toothbrushes, they usually hand out free samples to their patients. This invention no doubt will give dentists a better way of promoting their recommendation to change the toothbrushes every month as imprinted on the newly distributed samples. Should a person choose to replace their toothbrushes only every two or more months, it will still be very clear when they last replaced them, and therefore will need to acquire appropriate new “Brush-A-Month” toothbrushes from a nearby store.

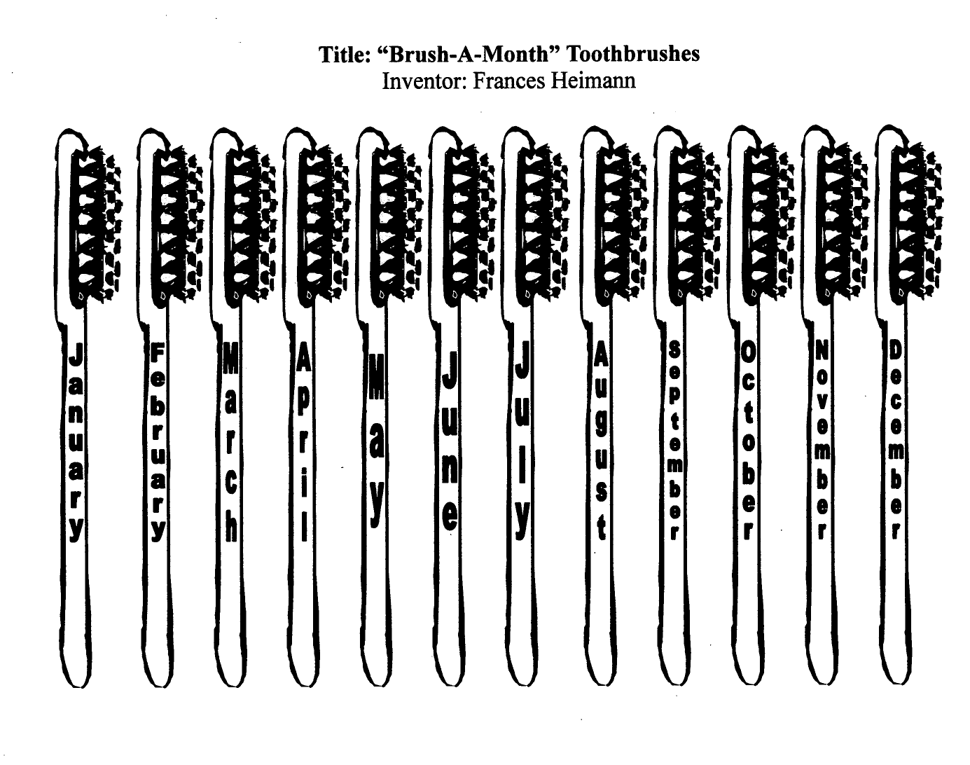

### FIELD OF THE INVENTION

The invention's concept relates to the recommendation by the American Dental Association to have all their patients change toothbrushes on an approximate monthly basis.

### CROSS-REFERENCE TO RELATED APPLICATIONS

“Not applicable”

### STATEMENT REGARDING FEDERALLY SPONSORED RESEARCH OR DEVELOPMENT

“Not applicable”

### REFERENCE TO SEQUENCE LISTING A TABLE, OR A COMPUTER PROGRAM LISTING COMPACT DISC APPENDIX

“Not applicable”

### BACKGROUND OF THE INVENTION

In every household there is no question that everyone uses their toothbrush far beyond the recommended time frames. This invention will help solve that dilemma.

### BRIEF SUMMARY OF THE INVENTION

Rather than guessing when it is time to replace one's toothbrush with a new one, this invention only requires one to know what month of the year it is.

### BRIEF DESCRIPTION OF THE DRAWING

The attached drawing is a view of the embossed/engraved toothbrushes with each month of the year depicted. One could use different kinds of fonts to imprint the words, but regardless the idea is to foster the change of brushes every month. Since the invention does not involve any technical issues, the drawing does not portray a technical process, but merely represents the idea that brushes should be changed regularly.

### DETAILED DESCRIPTION OF THE INVENTION

A thorough review of the patents available for toothbrushes did not reveal a reference to monthly reminders. The invention therefore involves imprinting each month of the year on the handles of handheld, or on the removable heads of electric toothbrushes. Though there are many web sites that speak of monthly toothbrush delivery services, none of them actually depict or mention any given month on their products.

The process involves using toothbrushes which have enough space on their handles to emboss the name of each month of the year. The engravings are simply made by using any engraving tool to etch/imprint the appropriate month. The specific manufacturers of any brand of toothbrush, be it handheld or electric, can easily incorporate the idea on their individual products, and can therefore advertise that they follow the recommendations of the American Dental Association.

1. What I claim as my invention is: “that my invention will allow users to easily follow the monthly toothbrush replacement guidelines most dentists recommend ”. I further claim that my invention/idea of permanently marking a toothbrush with a specific month: “will remind users to replace their toothbrush, or electric brush head in a timely manner ”. What I claim as my invention is: “it will promote better dental hygiene, due to the regular monthly replacements of used toothbrushes ”. What I claim as my invention is: “it will no doubt cause dentists and hygienists to encourage their patients to make use of these reminder toothbrushes, which in the long-run will create a healthier and a more satisfied clientele”. What I claim as my invention is: “that children will urge their parents to actually replace their individual used toothbrushes every month”.
